(19) United States
(12) Patent Application Publication
(10) Pub. No.: US 2023/0368357 A1
(43) Pub. Date: Nov. 16, 2023

(54) VISIBILITY MEASUREMENT DEVICE

(71) Applicant: Bristol Industrial and Research Associates Limited, Portishead Bristol (GB)

(72) Inventors: Paul Smith, Portishead Bristol (GB); Alec Bennett, Portishead Bristol (GB); Matthew Bennett, Portishead Bristol (GB)

(21) Appl. No.: 18/247,045

(22) PCT Filed: Oct. 6, 2020
(86) PCT No.: PCT/GB2020/052467

§ 371 Date: Mar. 28, 2023

(51) Int. Cl. G06T 7/00; G06T 7/55; H04N 23/698; H04N 23/695

(52) U.S. Cl. CPC G06T 7/0002; G06T 7/55; G06T 7/97; H04N 23/698; H04N 23/695; G06T 2207/30168; G06T 2207/30192

(57) ABSTRACT

A visibility measurement device (10) comprising a camera (12) and a computing device (14) communicatively coupled to the camera and configured to: receive a first image from the camera; select a measurement feature in the first image, the measurement feature corresponding to a location within the field of view of the camera; measure an optical characteristic of the measurement feature to obtain a measured optical characteristic value for the location; and determine an ambient fog intensity value based on: the measured optical characteristic value; a reference optical characteristic value for the location; and a distance between the camera and the location, such that the ambient fog intensity value can be used to calculate the visibility in a direction between the camera and the location.

### FIELD

This invention relates to a device for measuring visibility under a variety of atmospheric conditions.

### BACKGROUND

Visibility is usually referred to as the maximum horizontal distance through the atmosphere that objects can be seen by the unaided eye.

Estimation of visibility can be particularly important in aviation, for example in areas near airports, where visibility determines the distance at which a runway is visible to a pilot on approach.

A known method for measuring visibility involves positioning large, dark coloured markers at distances from an observation point and manually assessing the furthest distance that they are visible.

More modern methods use specialised instruments that project light in a predefined direction and measure the amount of scattering by particles suspended in the air and/or absorption of visible light to calculate an extinction coefficient, which can be used to estimate visibility in the direction of the emitted light.

The present inventors have devised a new visibility measurement device that can provide improved accuracy relative to known devices.

### SUMMARY

In accordance with a first aspect of the present invention, there is provided a visibility measurement device comprising a camera and a computing device communicatively coupled to the camera and configured to:
receive a first image from the camera;
select a measurement feature in the first image, the measurement feature corresponding to a location within the field of view of the camera;
measure an optical characteristic of the measurement feature to obtain a measured optical characteristic value for the location; and
determine an ambient fog intensity value based on:
   the measured optical characteristic value;
   a reference optical characteristic value for the location; and
   a distance between the camera and the location,
      such that the ambient fog intensity value can be used to calculate a first visibility in a direction between the camera and the location.

Thus the invention can reduce the need for manual input and can enable an automatic, quick and objective determination of the visibility in a first direction.

The computing device can determine the first visibility and output a signal representative of the first visibility.

The optical characteristic can be any of intensity, brightness, or colour hue.

The reference optical characteristic value can be determined based on a reference feature corresponding to the location in a second image. The second image can be distinct from the first image and define an image having different visibility characteristics in comparison to the first image. The second and first images are preferably taken from the same position and camera orientation.

The visibility measurement device can be arranged to identify one or more further measurement features within the first image, each further measurement feature corresponding to a distinct location within the field of view of the camera, wherein the step of determining the ambient fog intensity value comprises iteratively optimising the ambient fog intensity value based on the respective values of measured optical characteristic; reference value of the optical characteristic; and the distance for some or all of the measurement features, until the respective measured optical characteristic of each measurement feature is equal to an estimated optical characteristic of each of the selected features.

The computing device can receive a third image captured from a different location than the first image, identify a comparison feature in the third image that corresponds to the location and use the position of the measurement and comparison features within the respective images to determine by way of photogrammetry the distance between the first camera and the location. The third image can be captured at a known distance from the point at which the first image was captured. Similar calculations can be performed for any further measurement features using corresponding comparison features.

The visibility measurement device can store the distance between the camera and the location in a database. In some embodiments, the database can be a local database, stored in a memory of the computing device. In other embodiments the database can be an online database stored in a remote online server.

The visibility measurement device can comprise a further camera, the further camera having a known spatial relationship with respect to the camera and being configured to capture the third image. In other words, the further camera can be positioned at a known distance to the camera and can be either part of the same assembly, or be distinct from the assembly of the first camera but arranged to be communicatively coupled to the visibility measurement device.

The camera can alternatively be configured to move a known distance to capture the third image.

The visibility measurement device can be arranged to calculate the first visibility.

The first camera can be arranged to rotate and capture multiple images that are combined to generate a panoramic image, with a field of view of 30 degrees-360 degrees, and preferably a field of view of 180 degrees-360 degrees. Capturing a panoramic image with an expanded field of view enables the visibility measurement device to determine the visibility in multiple directions from the first camera.

In accordance with a second aspect of the present invention, there is provided a computer implemented method of measuring visibility, the method comprising:
receiving a first image from a first camera;
selecting a measurement feature in the first image, the measurement feature corresponding to a location within the field of view of the camera;
measuring an optical characteristic of the measurement feature to obtain a measured optical characteristic value for the location;
determining an ambient fog intensity value based on:
   the measured optical characteristic value;
   a reference optical characteristic value for the location;
   a distance between the camera and the location; and
using the ambient fog intensity value to calculate a first visibility in a direction between the camera and the location.

The method can comprise identifying one or more further measurement features within the first image, each further measurement feature corresponding to a distinct location within the field of view of the camera and the step of determining the ambient fog intensity value can comprise iteratively optimising the ambient fog intensity value based on the respective values of measured optical characteristic; reference value of the optical characteristic; and the distance for some or all of the measurement features, until the respective measured optical characteristic of each measurement feature is equal to an estimated optical characteristic of each of the selected features.

The method can comprise receiving a third image captured from a different location than the first image, identify a comparison feature in the third image that corresponds to the location and use the position of the measurement and comparison features within the respective images to determine by way of photogrammetry the distance between the first camera and the location. The third image can be captured at a known distance from the point at which the first image was captured. Similar calculations can be performed for any further measurement features using corresponding comparison features.

Further optional features of the first aspect can be applied to the second aspect in an analogous manner.

### BRIEF DESCRIPTION OF THE DRAWINGS

By way of example only, certain embodiments of the invention will now be described by reference to the accompanying drawings, in which:

FIG. 1 is a diagram of a visibility measurement device according to a first embodiment of the invention;

FIG. 2a is a diagram of a first, measurement image containing three measurement features;

FIG. 2b is a diagram of a second, reference image containing three reference features;

FIG. 3 is a diagram of a visibility measurement device according to a second embodiment of the invention;

FIG. 4 is a diagram of a visibility measurement device according to a third embodiment of the invention;

FIG. 5 is a diagram of a pair of images image showing measurement features used to determine a distance to an object represented by the feature;

FIG. 6 is an illustration of a method according to an embodiment of the invention; and

FIG. 7 is an illustration of a method according to a further embodiment of the invention.

### DETAILED DESCRIPTION

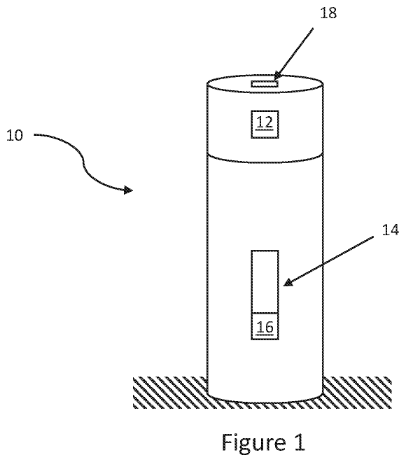

FIG. 1 is a diagram of a visibility measurement device 10 according to an embodiment of the invention.

The visibility measurement device 10 comprises a camera 12 and a computing device 14.

The camera 12 can be any suitable digital camera and can therefore comprise a sensor sensitive to visible light, i.e. electromagnetic radiation with a wavelength between about 350 to 750 nanometers. In some embodiments the sensor can be sensitive to wavelengths greater than 750 nanometers and/or lesser than 350 nanometers.

In the embodiment of FIG. 1 the camera 12 is movably mounted on the body of the visibility measurement device 10, so that it can rotate and tilt to point in different directions, whilst being spatially fixed in relation to the body of the visibility measurement device 10 at a primary movement axis. Thus the camera 12 has two degrees of freedom of movement. In other embodiments, the camera 12 can for example rotate about the longitudinal axis of the visibility measurement device 10 but cannot tilt, thus only having one degree of freedom of movement. In other embodiments the camera 12 can be fixed on the body of the visibility measurement device 10 such that it cannot move and thus always points towards the same direction.

Advantageously, having a camera that can rotate and/or tilt enables the capturing of images in a variety of different directions. This enables the visibility measurement device 10 to measure the visibility in different directions, e.g., in the case of rotation, in multiple octants (N, NE, SW etc.)

In some embodiments, the camera 12 can be configured to rotate and capture multiple images that are combined by the computing device 14 to generate a panoramic image, with a field of view of 30 degrees-360 degrees, and preferably a field of view of 180 degrees-360 degrees. Advantageously, capturing a panoramic image with an expanded field of view can enable the visibility measurement device to simultaneously determine the visibility in multiple directions from the camera, e.g. in multiple octants (N, NE, SW etc.)

In the embodiment of FIG. 1 the camera 12 comprises a lens of fixed focal length. Alternatively, the camera 12 can comprise a lens with variable focal length, which allows the camera to zoom in on a direction or zoom out to increase the available field of view of the camera 12.

The computing device 14 is communicatively coupled to the camera 12 through a wireless or wired connection (not shown). The computing device 14 can have one or more local or distributed processing cores (not shown), network interface (not shown), and volatile and non-volatile memory 16. The memory can store images, video, or metadata for example.

The computing device 12 is configured to run a computer implemented algorithm that uses images to produce data that can be used to calculate visibility.

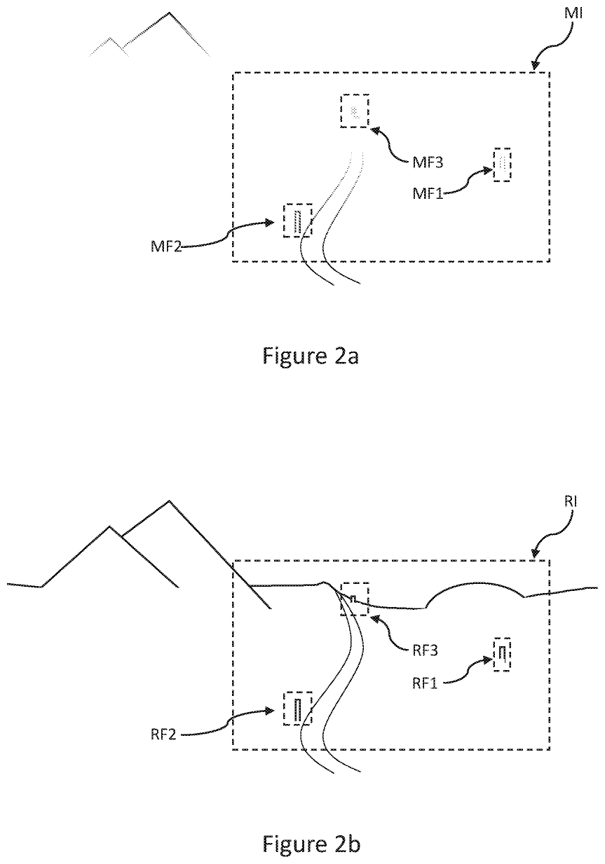

Referring additionally to FIG. 2a, when determining the current visibility, the computing device 14 is configured to obtain an image from the camera 12. This will be referred to as a measurement image MI. The computing device 14 select a measurement feature MF1 comprising a group of picture elements or pixels that represent a physical location within the field of view of the camera 12. The location can be anything that results in a discernible feature within an image.

The visibility measurement device 12 obtains or measures the distance from the camera 12 to the location. The visibility measurement device 10 can for example comprise a database stored on a local memory 16, or remote memory accessible by the device 12. The database comprises a table of distances between the location of the camera 12 and one or more plurality locations in the environment of the camera 12 that can serve as measurement features.

An optical characteristic of the measurement feature MF1 is then determined. In the embodiment of FIG. 1, the optical characteristic is the intensity of the measurement feature MF1. The computing device 14 determines the intensity by selecting the darkest pixel of the measurement feature MF1. The darkest pixel can be the pixel with the lowest brightness value. The use of the darkest pixel can lead to a greater contrast/difference between good and poor visibility intensities, increasing the accuracy of the visibility measurement. The use of the darkest pixel can further help to correct small alignment errors in matched features between different images of the same areas/objects. Furthermore, the use of the darkest pixel can reduce the chance of bright background pixels close to a selected measurement feature (such as the sky) being inappropriately compared.

Thus, in the embodiment of FIG. 1, the visibility measurement device 10 determines a measured intensity Iₘ of the first measurement feature MF1 based on the first image MI.

Referring additionally to FIG. 2b, the visibility measurement device 10 also has access to a reference value of the optical characteristic for a reference feature RF1, which corresponds to the measurement feature MF1. The reference feature RF1 can comprise a group of picture elements or pixels in a reference image RI that represent the same real location, but under different visibility conditions. The reference image RF1 is preferably captured on a day with good weather conditions, or in other words captured under conditions that enable maximum visibility. The optical characteristic of the reference feature RF1 can be stored in a memory or database that is accessible by the computing device 14, such as the local memory 16, for use with subsequently taken measurement images MI.

Thus, in the embodiment of FIG. 1, the visibility measurement device 10 has access to a reference intensity value Iᵣ for the reference feature RF1.

The visibility measurement device 10 then calculates an estimated intensity Iₑ of the measurement feature MF1 based on equation (1):

Iₑ=[e^{-k+d}*(Iᵣ−I_{f})] (1)

where:
d is the distance of the measurement feature MF1 from the first camera 12;
I_{f} is the ambient fog intensity, also known as ambient fog density, scatter intensity, backscatter intensity, scatter value or ambient fog intensity value;
Iᵣ is the reference intensity of the first measurement feature MF1; and
k is the atmospheric extinction coefficient.

The visibility measurement device 10 then determines the values of k and I_{f} such that the estimated intensity Iₑ is equal to the measured intensity Iₘ of the feature MF1. The skilled person will recognise that solving for k and I_{f} such that Iᵣ is equal to a specific value is an optimisation problem, which can be solved by employing a variety of known algorithms e.g. a non-linear least-squares optimisation algorithm that minimises the squared error between estimated and measured feature point intensities.

Once the visibility measurement device calculates the value of I_{f} for which Iₑ=Iₘ, the system calculates the contrast of the measurement feature MF1 based on the following equation (2):

$$C = \frac{{I}_{m} - {I}_{f}}{{I}_{r} - {I}_{f}} \qquad ( 2 )$$

Once the contrast C of the measurement feature MF1 is determined, visibility V in the direction of the MF1 in the image MI can be calculated based on equation (3)

$$V = - d \frac{ln ( 0.05 )}{- ln ( C )} . \qquad ( 3 )$$

The visibility measurement device 10 can be configured to output a signal representative of a calculated visibility, or can for example simply output the contrast C for another process or user to use to calculate the visibility.

Thus, in order to measure the visibility of a single feature point, the intensity, reference intensity and distance are used. Two global constants are also used, these being the ambient fog intensity, so you can see how close a feature intensity is to the ambient i.e. know the contrast, and the extinction coefficient, to convert contrast to visibility. Knowing the two global constants for the scene, the system can calculate the visibility for a measurement feature without reference to any other feature points.

While the above description focuses on a single measurement feature MF1, solving equation (1) for k and I_{f} such that the estimated intensity Iₑ is equal to the measured intensity Iₘ may utilise multiple measurement features in multiple directions. For example, in addition to first measurement feature MF1, the visibility measurement device also selects additional measurement features MF2 and MF3. The measurement features can for example represent objects at various distances from the first camera 12. In cases where the two global constants are unknown for a given scene, they can be estimated by an optimisation algorithm. An optimisation algorithm may iterate over some or all of the measurement features using the constants in equation 1 to find the values of k and I_{f} that result in the smallest error between the respective estimated intensity and measured intensity for each selected measurement feature. Once a consensus is found, the two global constants are associated with the scene. Any feature point in the scene can then have its visibility calculated independently. As such, embodiments involving the use of multiple measurement points can determine the visibility for a measurement point in the image without any pre-existing knowledge of what is in the scene other than the distance to the measurement point.

Selecting multiple measurement features in multiple directions enables substantially concurrent estimations of visibility from the camera 12 towards their respective directions. This is advantageous when compared to known methods of estimating visibility which usually only calculate visibility towards one direction at any given time, with the process starting over when there is a need to estimate the visibility in a different direction.

In embodiments where the visibility measurement device 10 has selected multiple measurement features MF1 to MF3, a corresponding number of reference features RF1 to RF3 are utilised as described above and determination of the ambient fog intensity value using equation (1) comprises iteratively optimising the values of the atmospheric extinction co-efficient and the ambient fog intensity value for all of the selected features, until the respective measured intensity of each selected feature is equal to the respective estimated intensity of each of the selected features. In some embodiments, only a subset of the selected features are used to determine the ambient fog intensity value.

Where the image includes regions in different octants, measurement features can be grouped and in some cases averaged by octant. An orientation sensor such as an encoder can inform which direction the camera is facing when capturing an image.

While in the above-described embodiment the optical characteristic is intensity, in other embodiments the computing device 14 can determine the optical characteristic of a feature based on values of brightness, colour hue, saturation, tone or the like. In some embodiments, where the captured images are greyscale, the intensity of a feature can be the greyscale brightness of the image pixels that form the feature. In other embodiments, where the captured images are in colour, the image is converted to greyscale using an algorithmic combination of the red, green and blue components to enable the computing device 14 to extract a greyscale brightness.

Selecting a measurement feature can comprise ensuring that the measurement feature satisfies a set of requirements. The set of requirements can comprise having a brightness value greater than a pre-defined threshold or having a contrast value greater than a pre-defined threshold. Features can be identified and selected using any of the known feature or image matching techniques, for example the Orientated FAST and Rotated BRIEF (ORB) algorithm (E. Rublee, V. Rabaud, K. Konolige and G. Bradski “ORB: an efficient alternative to SIFT or SURF” in IEEE International Conference on Computer Vision, ICCV MI11, Barcelona, Spain, November 6-13, MI11). An intensity threshold is 15 set for a feature to be considered (relating to the intensity of a centre pixel and those in a circular ring around it, as per the FAST algorithm, and a measurement of “cornerness” calculated by the Harris response). Features that have been selected but whose determined contrast brightness or intensity is below a pre-defined threshold can be discarded. The computing device 14 can also limit the number of selected features per image chosen as a balance between information and computational requirements. The computing device 14 can also discard information relating to features that are determined to be approximately in the same distance and direction as other features. In embodiments utilising photogrammetry, a point cloud of measurement features can be generated.

In any embodiment, communication hardware (not shown) can be provided that enables the visibility measurement device 10 to communicate with a remote computing unit (not shown). The communication hardware can comprise an antenna, a transceiver, a wired connection, etc. The remote computing unit can comprise an online database which comprises a table of distances between the location of the camera 12 and a plurality of objects in the environment of the camera 12. The remote computing unit can provide to the visibility measurement device 10 the respective distances between the location of the camera 12 and a plurality of objects in the environment of the camera 12.

In such embodiments, the visibility measurement device 10 can provide to the remote computing unit the location of the camera 12 so that the remote computing unit can provide the distances between the location of the camera 12 and a plurality of objects in the environment of the camera 12.

In some embodiments, the visibility measurement device 10 can be configured to communicate wirelessly with user equipment (not shown). A user can use the user equipment to manually provide information about the location of the camera 12 to visibility measurement device 10. In some embodiments, a user can use the user equipment to capture an image of an area visible by the camera 12 and provide the image to the visibility measurement device 10 along with the location from which the image was taken.

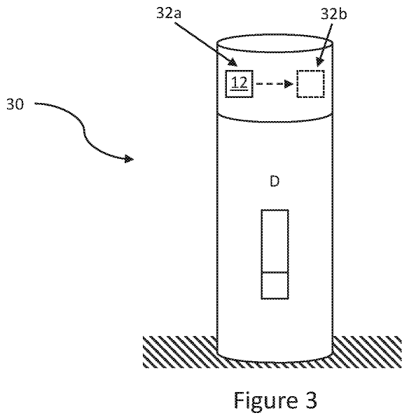

FIG. 3 shows a schematic diagram of a visibility measurement device 30 according to another embodiment of the invention. The visibility measurement device 30 is substantially similar to that of FIG. 1 and all of the above-mentioned optional features and variations can be applied to it. However, in the embodiment of FIG. 3, the first camera 12 is movably coupled to the body of the visibility measurement device 30 such that it can move a distance D from an initial position 32a to a spatially offset final position 32b in response to a signal from the computing device 14. The distance D can be a pre-defined distance, or it can be set by the computing device 14 based on the focal length of the lens of the first camera 12. By allowing the first camera to move a set distance D from the initial position 32a, the system can capture a third image of the same area from a spatially offset point of view. The offset between the camera positions can be in any plane, such as horizontal, vertical or an inclined plane.

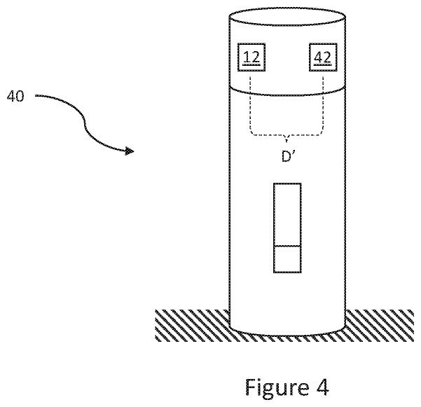

FIG. 4 shows a schematic diagram of a visibility measurement device 30 according to another embodiment of the invention. The visibility measurement device 40 is substantially similar to that of FIG. 1 and all of the above-mentioned optional features and variations can be applied to it. However, in the embodiment of FIG. 4, the visibility measurement device 40 also comprises a second camera 42, with the second camera positioned at a fixed distance D′ from the first camera 12. By having a second camera 42 at a known distance D′ from the first camera 12, the system can capture a third image of the same area from a spatially offset point of view. Although in the embodiment of FIG. 4 the first camera 12 and the second camera 42 are part of the same assembly, in other embodiments the second camera 42 can be distinct from the body of the visibility measurement device 40, but arranged to be communicatively coupled to the visibility measurement device 40. The second camera 42 can alternatively act as the main camera to improve the reliability of the visibility measurement device in case the first camera 12 becomes obstructed or unresponsive.

The visibility measurement device 30 and visibility measurement device 40 are configured to use the first image and the third image to measure the distance of objects that are visible in both the first image and the third image using photogrammetry. As the first image and the third image are images of the same area from spatially offset points of view, the computing device of visibility measurement device 30 and/or visibility measurement device 40 can automatically identify features in the first and third image that correspond to the same object. The computing device can use pattern matching or envelope matching algorithms to identify features in the first and third image that correspond to the same identified object. The computing device can determine the distance of the identified object from the first camera 12 based on the position of the corresponding feature in the first image, the position of the corresponding feature in the third image and the distance D in case of the visibility measurement device 30 or the distance D′ in case of the visibility measurement device 40.

As the visibility measurement devices 30 and 40 have the ability to measure both the intensity and the distance of the measurement features captured by the camera(s), the feature intensity and location reference values can be refreshed at times without manual intervention. This is advantageous should the environmental conditions change and affect the intensity of the imaged features while maintaining good visibility, e.g. in cases where the angle of sunlight changes, or if imaged objects are physically moved over time.

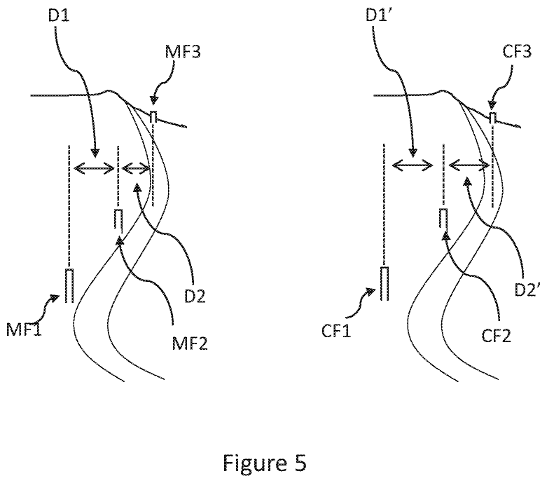

FIG. 5 shows a diagram of a pair of captured images showing measurement features used to determine a distance to locations represented by the features. In embodiments similar to the one illustrated in FIG. 4, which comprises two cameras, the left diagram would correspond to an image taken by the first camera 12 while the right diagram would correspond to an image taken by the second camera 42. In embodiments where the visibility measurement device comprises a single movable camera, like the one illustrated in FIG. 3, the left diagram would correspond to an image taken at a first point in time, while the right diagram would correspond to an image taken at a later point in time. As a result of imaging the same area from two different and spatially offset points, some features are spatially offset when comparing the two images.

In the captured images, measurement feature MF1 and comparison feature CF1 correspond to the same location, measurement feature MF2 and comparison feature CF2 correspond to the same location and measurement feature MF3 and comparison feature CF3 correspond to the same location. However, because the two images are captured from different vantage points, the objects that are closer to the camera have a greater displacement when compared with objects further from the camera. The computing device 14 can measure the distances D1, D1′, D2 and D2′ and determine the distance of the objects corresponding to imaged features using known photogrammetry algorithms. In some embodiments, the computing device 14 has access to look-up tables that associate a degree of displacement of a selected feature with a distance from the first camera 12.

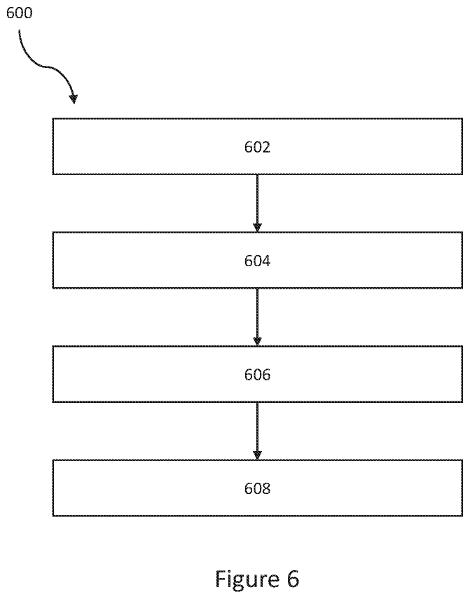

FIG. 6 shows an illustration of a method 600 according to an embodiment of the invention.

In step 602, the computing device 14 receives a first image from the camera 12. The first image can comprise one or more measurement features as described above.

In step 604, the computing device 14 selects a first measurement feature.

In step 606, the computing device 14 measures an optical characteristic of the measurement feature, preferably the intensity of the measurement feature as described previously.

In step 608, the computing device 14 determines an ambient fog intensity value in the direction of the location, as described above. In some embodiments, the reference value of the optical characteristic has been determined prior to step 602, based on a reference image of the location captured in good visibility conditions.

The ambient fog intensity value can be used to calculate visibility in a direction between the camera and the location.

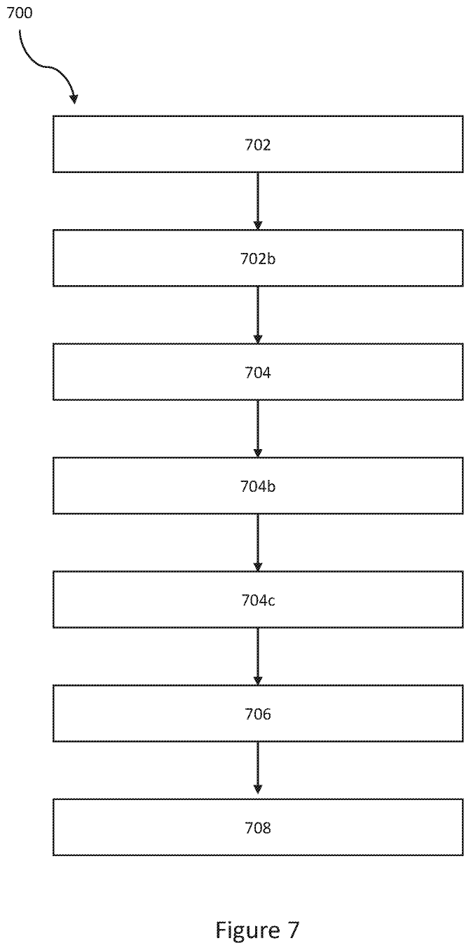

FIG. 7 is an illustration of a method 700 according to an embodiment of the invention where the visibility measurement device must determine the distance to the first location.

Step 702 corresponds to step 602. However, after step 702 concludes, the system proceeds to step 702b.

In step 702b the computing device 14 receives a third image captured from a different location than the first image. If the visibility measurement device comprises a movable camera as the one described in relation to FIG. 3, then receiving the third image comprises the computing device 14 instructing the first camera 12 to move a pre-defined distance D prior to capturing the second image. If the visibility measurement device comprises two cameras, as the device described in relation to FIG. 4 then receiving the third image comprises the computing device 14 receiving the third image from the second camera 42. In other embodiments, receiving the third image can comprise receiving an image comprising positioning metadata from a user equipment which enables the computing device to determine the distance between the vantage points of the first image and the second image.

Step 704 corresponds to step 604. However, after step 704 concludes, the system proceeds to step 704b.

In step 704b the computing device 14 identifies a comparison feature in the third image that corresponds to the measurement feature.

In step 704c the computing device 14 determines by way of photogrammetry the distance between the first camera 12 and the location. Once the distance between the first camera 12 and the location has been determined, the method proceeds to steps 706 and 708 which are similar to steps 606 and 608.

It should be noted that the above-mentioned embodiments illustrate rather than limit the invention, and that those skilled in the art will be capable of designing many alternative embodiments without departing from the scope of the invention as defined by the appended claims. AMENDMENTS TO THE CLAIMS

1. A visibility measurement device comprising a camera and a computing device communicatively coupled to the camera and configured to:
receive a first image from the camera;
select a measurement feature in the first image, the measurement feature corresponding to a location within the field of view of the camera;
measure an optical characteristic of the measurement feature to obtain a measured optical characteristic value for the location; and
determine an ambient fog intensity value based on:
the measured optical characteristic value;
a reference optical characteristic value for the location; and
a distance between the camera and the location,
such that the ambient fog intensity value can be used to calculate the visibility in a direction between the camera and the location.

2. The visibility measurement device of claim 1 wherein the computing device is further configured to determine the visibility and output a signal representative of the visibility.

3. The visibility measurement device of claim 1, wherein the optical characteristic is any of intensity, brightness, or color hue.

4. The visibility measurement device of claim 1, wherein the reference optical characteristic value is determined based on a reference feature corresponding to the location in a second image distinct from the first image.

5. The visibility measurement device of claim 1, wherein determining the ambient fog intensity value comprises iteratively optimizing the ambient fog intensity value based on the respective values of:
a measured optical characteristic value;
a reference optical characteristic value; and
a distance,
for one or more measurement features in the first image, until the respective measured optical characteristic of each selected measurement feature is equal to an estimated optical characteristic of each of the selected features.

6. The visibility measurement device of claim 1, wherein the computing device is configured to:
receive a third image captured from a different location than the first image;
identify a comparison feature in the third image that corresponds to the location;
use the position of the measurement and comparison features to determine by way of photogrammetry the distance between the first camera and the location; and store the distance in a database.

7. The visibility measurement device of claim 6, wherein:
the visibility measurement device comprises a second camera having a known spatial relationship with respect to the first camera and configured to capture the third image; or
the first camera is configured to move a known distance to capture the third image.

8. The visibility measurement device of claim 1, wherein the camera is configured to rotate to capture multiple first images in different directions such that the visibility measurement device can determine the visibility in corresponding multiple directions.

9. A computer implemented method of measuring visibility, the method comprising:
receiving a first image from a first camera;
selecting a measurement feature in the first image, the measurement feature corresponding to a location within the field of view of the camera;
measuring an optical characteristic of the measurement feature to obtain a measured optical characteristic value for the location;
determining an ambient fog intensity value based on:
the measured optical characteristic value;
a reference optical characteristic value for the location; and
a distance between the camera and the location; and
using the ambient fog intensity value to calculate the visibility in a direction between the camera and the location.

10. The method of claim 9, wherein the first characteristic is any of intensity, brightness, or color hue.

11. The method of claim 9, wherein the reference optical characteristic value is determined based on a reference feature corresponding to the location in a second image.

12. The method of claim 9, comprising:
identifying one or more further measurement features within the first image, each further measurement feature corresponding to a distinct location within the field of view of the camera and the step of determining the ambient fog intensity value comprising iteratively optimizing the ambient fog intensity value based on:
the respective values of measured optical characteristic;
reference value of the optical characteristic; and
the distance for some or all of the measurement features,
until the respective measured optical characteristic of each measurement feature is equal to an estimated optical characteristic of each of the selected features.

13. The method of claim 9, comprising:
receiving a third image captured from a different location than the first image;
identifying a comparison feature in the third image that corresponds the location and use the position of the measurement and comparison features within the respective images to determine by way of photogrammetry the distance between the first camera and the location,
wherein the third image is captured at a known distance from the point at which the first image was captured.
